(19) United States
(12) Patent Application Publication
(10) Pub. No.: US 2016/0175935 A1
(43) Pub. Date: Jun. 23, 2016

(54) DEVICE FOR THE ADDITIVE MANUFACTURE OF A COMPONENT

(71) Applicant: MTU Aero Engines AG, Munich (DE)

(72) Inventors: Alexander Ladewig, Bad Wiessee (DE); Steffen Schlothauer, Erdweg (DE); Christian Liebl, Bockhorn (DE); Georg Schlick, Munich (DE); Maximilian Fisser, Tegernsee (DE)

(21) Appl. No.: 14/959,894

(22) Filed: Dec. 4, 2015

(30) Foreign Application Priority Data
Dec. 17, 2014 (DE) 10 2014 226 243.7

(51) Int. Cl. B22F 7/02

(52) U.S. Cl. CPC B22F 7/02; B33Y 30/00

(57) ABSTRACT

The invention relates to a device (10) for the additive manufacture of a component (12), comprising at least one coating device (14) for producing a powder layer (16) on a construction platform (18); at least one radiation source (20), in particular a laser, for producing a high-energy beam (24), by means of which the powder layer (16) in a construction surface area (22) can be melted and/or sintered locally to form a component layer (30); at least one deflection device (26), by means of which the high-energy beam (24) can be deflected onto different regions of the powder layer (16) and can be focused on the construction surface area (22); at least one measurement system (28), by means of which a cross-sectional geometry of the high-energy beam (24) on the powder layer (16) and/or the component layer (30) can be determined; and at least one equilibration device (32).

### BACKGROUND OF THE INVENTION

The invention relates to a device for the additive manufacture of a component as well as a method for operating such a device.

Devices for the additive manufacture of components, such as laser-beam melting systems, for example, operate with a focused high-energy beam or laser beam that melts and/or sinters powder-form initial material that has been introduced as a layer onto a construction platform, to form a solid layer of a component. In this case, the correct and uniform focusing of the high-energy beam over the entire construction platform is of great importance. The cross-sectional geometry of the high-energy beam and thus its local energy density that are part of the core values of the additive manufacturing method are influenced by the focus. It is known from GB 2490143 A to arrange a beam splitter in the beam path of the high-energy beam, in order to determine the cross-sectional geometry of the high-energy beam. The cross-sectional geometry can then be changed by means of a movable mirror in the beam path, in order to produce a specific exposure profile with a desired energy density distribution on the powder layer.

The exact focus position is usually adjusted once by a relatively complex method prior to the manufacture of the component in question. It has been observed, however, that such devices are subject to a drift that is presumably thermally or mechanically caused, and this drift can lead to an undefined maladjustment of the focus position during the manufacturing process. This maladjustment of the focus position leads to an imprecise exposure profile and thus to disruptions in the process as well as material defects, from which results an inferior component quality.

### BRIEF SUMMARY OF THE INVENTION

The object of the present invention is to indicate a device and a method for the additive manufacture of a component, which make possible the adjustment of an exact focusing of the high-energy beam during the entire manufacturing process of a component.

The object is achieved according to the invention by a device for the additive manufacture of a component as well as by a method according to the present invention for operating such a device. Advantageous embodiments with appropriate enhancements of the invention are indicated in the respective dependent claims, wherein advantageous embodiments of the device can be viewed as advantageous embodiments of the method, and vice versa.

A first aspect of the invention relates to a device for the additive manufacture of a component. The adjustability of an exact focusing of the high-energy beam during the entire manufacturing process of the component is made possible according to the invention in that the device comprises at least one coating device for producing a powder layer on a construction platform; at least one radiation source, in particular a laser, for producing a high-energy beam, by means of which the powder layer in a construction surface area can be melted and/or sintered locally into a component layer; at least one deflection device, by means of which the high-energy beam can be deflected onto different regions of the powder layer and can be focused on the construction surface area; at least one measurement system, by means of which a cross-sectional geometry of the high-energy beam on the powder layer and/or the component layer can be determined; and at least one equilibration device. In this case, the equilibration device is designed for the purpose of determining a focus area of the high-energy beam based on the cross-sectional geometry of the high-energy beam, in order to examine whether a deviation is present between the construction surface area and the focus area of the high-energy beam, and to align the construction surface area and the focus area as a function of this examination. In other words, it is thus provided according to the invention that the device is designed for the purpose of determining a relative displacement of the focus area along the z-axis of the construction platform and/or a tilting between the focus area of the high-energy beam and the construction surface area of the powder layer or component layer even during the manufacturing process of the component, and to align the focus area and the construction surface area to one another correctly again in the case of an inadmissible deviation. A component quality that remains uniformly high can be assured in this way, since any drift between the focus area and the component surface area can be detected and equilibrated by means of the device according to the invention, even during the construction job, in the sense of an on-line monitoring. For this purpose, it is of advantage that the measurement system can determine the actual cross-sectional geometry of the high-energy beam on the powder layer and/or the component layer, since indirect measurement systems that only measure the cross-sectional geometry in the beam path of the device itself, but not the cross-sectional geometry on the powder surface or component surface, cannot detect a subsequent disruption that leads to a displacement or tilting of the focus area relative to the construction surface area. The measurement system used in the scope of the invention is preferably adapted to the properties of the high-energy beam to be measured, and records, for example, the wavelength of a processing laser (e.g., 1064 nm), in order to image the laser spot as precisely as possible and to be able to determine its cross-sectional geometry. In the simplest embodiment, the focus area and the construction surface area are each planes that are disposed or maintained parallel or congruent by means of the device according to the invention. Alternatively or additionally, however, it can also be provided that the focus area and/or the construction surface area are non-planar, whereby the focus of the high-energy beam can be optimally adapted, for example, to a respective arc dimension of a curved component layer being manufactured. The device according to the invention can basically be used not only for the manufacture, but also for the repair of a component, i.e., for the additive restoration of a component region.

In an advantageous embodiment of the invention, it is provided that the deflection device comprises at least one optical lens, in particular an f-theta objective, the relative position of which can be adjusted with respect to the radiation source as a function of the examination by means of at least one associated adjusting means. This permits a particularly simple assurance of a planar focus area as well as a simple aligning of focus area and construction surface area to one another, by correspondingly correcting the tilt and/or the distance of the at least one optical lens from the radiation source via the associated one or more adjusting means when an inadmissible deviation occurs. For example, the at least one optical lens can be designed as an f-theta objective known in and of itself and mounted in a movable manner. With the help of one, two, or three adjusting means, which can be designed, for example, as actuators, and can be controlled independently of one another, the spatial position of the f-theta objective can then be adjusted as a function of the determined misalignment between focus area and construction surface area, in order to again correctly align both areas to one another.

Additional advantages result by associating a kinematic mechanism, especially a parallel kinematic system, with the at least one optical lens, by means of which mechanism, the at least one optical lens can be moved in at least three translational and/or rotational degrees of freedom. This makes possible the adjustment of the at least one optical lens with high dynamics and high accelerations as well as final speeds, whereby a correspondingly more rapid manufacture or re-adjustment of focus area and construction surface area can be assured. In addition, the positioning accuracy of the optical lens is basically improved with a parallel kinematic system, since positioning errors of the axes are not additive, as they are in the case of a serial kinematic mechanism, but only enter into the total movement proportionally. A particularly high component quality is assured hereby.

Further advantages result when the equilibration device is designed for bringing about an actuation of the radiation source and/or the deflection device, as a function of the examination. It is assured in a constructively simple way thereby that changes that result due to the new alignment of focus area and construction surface area to one another can be correspondingly considered in the actuation of the radiation source and/or the deflection device. This permits a reliable correction of the original machine coordinates, which could otherwise be erroneous due to the new calibration of the focus area, and contributes to the assurance of a particularly high component quality. In addition, in this way, the device can be designed advantageously without f-theta optics, and instead be provided with a dynamic focusing system.

In another advantageous embodiment of the invention, it is provided that the measurement system is integrated and/or designed in a beam path of the high-energy beam, so as to determine the cross-sectional geometry of the high-energy beam collinear to the high-energy beam. By integrating a measurement system into the beam path of the high-energy beam, it is possible to produce a very high-resolution image of the high-energy beam (laser spot), whereby the high-energy beam that is beamed back by the powder layer or the component layer is drawn on as the foundation for determining the cross-sectional geometry. In this case, the integration can be carried out basically modularly for the one-time adjustment and for routine examination. Alternatively or additionally, the measurement system can also be integrated into the beam path for an examination prior to each construction job and/or during a construction job, or can be integrated permanently in the beam path. It is advantageously assured thereby that the measurement system, since it is integrated into the beam path, automatically measures the cross-sectional geometry at the correct position.

Further advantages result by designing the equilibration device to adjust a relative position of the construction platform with respect to the radiation source as a function of the examination. In other words, it is provided according to the invention that alternatively or in addition to an adaptation in the optical system of the device, an adjustment of the spatial position of the construction platform can be carried out in order to correctly align the focus area and the construction surface area to one another.

In another advantageous embodiment of the invention, it is provided that the equilibration device is designed in order to determine the focus area based on a comparison between at least one determined cross-sectional geometry, of the high-energy beam and at least one pre-specified cross-sectional geometry, and/or based on the cross-sectional geometry of the high-energy beam in at least three non-collinear measurement points, and/or based on at least a minimum cross-sectional geometry of the high-energy beam at one measurement point. In other words, it is provided that, based on the cross-sectional geometry of the high-energy beam, it is established whether the high-energy beam is in focus by conducting a comparison between the determined cross-sectional geometry and a pre-specified cross-sectional geometry. The focus area can then be determined from this. Alternatively or additionally, a measurement of the cross-sectional geometry can be carried out in at least three non-collinear measurement points that are preferably spaced as far apart as possible from one another in order to determine the focus area. In the simplest embodiment, i.e., in the case of a focus plane, three measurement points are sufficient. Likewise, it can be provided that a minimum cross-sectional geometry of the high-energy beam is determined in at least one measurement point in order to determine the spatial coordinates of the assigned focal point. This can be conducted, for example, by moving and/or tilting the plane of the construction platform and recording the resulting cross-sectional geometry of the high-energy beam. When the minimum cross-sectional geometry is reached, the high-energy beam will be in focus.

Other advantages result if a measuring instrument, in particular a glass ruler and or a test bar fabricated additively with the component is associated with the equilibration device, and, by means of this measurement device, a distance between the radiation source and the powder layer can be determined. This represents a structurally simple possibility for also determining the z-coordinate in addition to the x/y-coordinates of the high-energy beam on the powder layer or the component layer. A glass ruler is a ruler with very fine divisions and is made of ground glass, sometimes also of glass-like plastics. The advantage of glass and glass ceramics is their very small thermal expansion, so that temperature fluctuations barely have an influence on the dimensional stability. Alternatively or additionally, a test bar can be constructed additively with the component and can be used for determining the z-coordinate.

A second aspect of the invention relates to a method for operating a device according to one of the preceding exemplary embodiments. In this case, the adjustment of an exact focusing of the high-energy beam during the entire manufacturing process of a component is made possible according to the invention, in that the method at least comprises the steps of: determining at least one cross-sectional geometry of the high-energy beam on the powder layer and/or the component layer by means of the measurement system; determining the focus area of the high-energy beam based on the at least one cross-sectional geometry of the high-energy beam by means of the equilibration device; examining by means of the equilibration device whether a deviation is present between the construction surface area and a focus area of the high-energy beam; and aligning the construction surface area and the focus area to one another as a function of this examination. In other words, in order to avoid inadmissible deviations of the focus area and the construction surface area, and thus in order to avoid disruptions in the process and quality deficiencies, the focus area of the high-energy beam is determined at least once, and if necessary, aligned again relative to the construction surface area, which takes place both offline as well as online or during the construction job. Additional features and the advantages thereof can be derived from the descriptions of the first aspect of the invention, wherein advantageous embodiments of the first aspect of the invention are to be viewed as advantageous embodiments of the second aspect of the invention, and vice versa.

In an advantageous embodiment of the invention, it is provided that the power of the high-energy beam is adjusted when the cross-sectional geometry is determined, in such a way that the powder layer is not melted and/or sintered at the measurement point. It is reliably assured in this way that the determination of the focus area takes place without intervention in the actual manufacturing process and without damage to already produced component layers.

In another advantageous embodiment of the invention, it is provided that the focus area of the high-energy beam is determined on the basis of the cross-sectional geometry of the high-energy beam in at least three non-collinear measurement points. This represents a particularly rapid and simple possibility for determining the focus area. In the simplest case of a focus plane, three measurement points are sufficient in order to be able to correctly define the focus plane. In the case of geometrically more complex focus areas, four or more measurement points may be necessary for a clear determination. Preferably, the at least three measurement points are selected in such a way that they are disposed spaced apart from one another as far as possible, since a particularly precise determination of the focus area is assured in this way.

In another advantageous embodiment of the invention, it is provided that the construction platform is moved relative to the radiation source in order to determine a minimum cross-sectional geometry of the high-energy beam. Although the determination of the focus position at a measurement point can also be carried out basically by a comparison between the determined cross-sectional geometry and a pre-defined cross-sectional geometry, the determination of the optimal focus position by moving the construction platform offers the particular advantage that the minimum cross-sectional geometry is determined directly on the respective component or powder bed, so that individually occurring thermal or mechanical deviations can be better taken into consideration. When the construction platform is moved, the resulting cross-sectional geometry of the high-energy beam is determined. When the minimum cross-sectional geometry is reached, the high-energy beam will be in focus at this measurement point. The measurement point determined in such a way can then be drawn on for further determining the focus area.

Additional advantages result by moving the construction platform for determining the minimum cross-sectional geometry continuously, and/or at least by the Rayleigh length of the high-energy beam, and/or by at least 20 mm, and/or stepwise by a pre-specified step, in particular by 10% of the Rayleigh length of the high-energy beam. In this way, it is assured that this involves the minimum cross-sectional geometry of the high-energy beam around a global minimum.

In another advantageous embodiment of the invention, it is provided that at least the examination of whether a deviation is present between the construction surface area and the focus area of the high-energy beam is carried out continuously, and/or at pre-determined time intervals, and/or after each component layer that is produced, and/or prior to a pre-defined component layer, and/or as a function of a heating of the device. In this way, the method according to the invention can be conducted as needed and can be optimally adapted to the respective construction job, whereby, in addition to a high precision and high component quality, minimum time delays are also assured by the examination, and the correction of the alignment of focus area and construction surface area to one another, which may be necessary, is also assured.

### BRIEF DESCRIPTION OF THE DRAWINGS

Additional features of the invention result from the claims, the exemplary embodiment, and on the basis of drawings. The features and combinations of features named above in the description, as well as the features and combinations of features named in the example of embodiment below can be used not only in the combination indicated in each case, but also in other combinations, without departing from the scope of the invention. Here:

FIG. 1 shows a schematic sectional view of an exemplary embodiment of a device according to the invention for the additive repair of a component;

FIG. 2 shows a schematic top view of a component layer that has been exposed with 15 individual vectors aligned parallel to a direction of laser exposure;

FIG. 3 shows a schematic top view of a component layer that has been exposed with 15 individual vectors aligned perpendicular to the direction of laser exposure; and

FIG. 4 shows an illustration of the principle of the resulting track widths of the individual vectors.

### DETAILED DESCRIPTION OF THE INVENTION

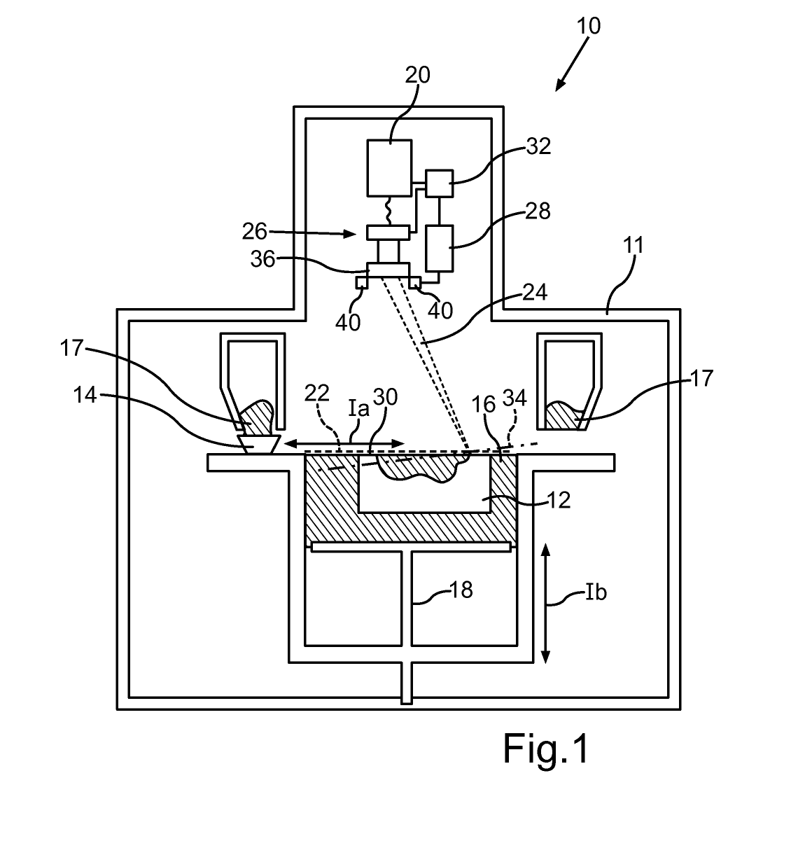

FIG. 1 shows a schematic sectional view of an exemplary embodiment of a device 10 according to the invention for the additive manufacture or repair of a component 12, which is designed presently as a rotating blade of a turbine of an aircraft engine. The device 10 comprises a process chamber 11, in which a coating device 14 that can be moved according to double arrow Ia for producing a powder layer 16 from a component material 17 is disposed on a construction platform 18. In its turn, the construction platform 18 can be moved according to double arrow Ib, and in addition, can be optionally designed as rotatable and/or pivotable. In equipping the device 10, the construction platform 18 can be aligned with the coating device 14 by rotation about the x- and y-axes, so that a uniform application of the powder layer 16 over the construction platform 18 can be assured. This may be necessary, since the upper side and the underside of the construction platform 18 are often not exactly parallel to one another. In addition, a radiation source 20 that is presently designed as a laser, is provided, by means of which a high-energy beam or laser beam 24 is produced in the region of a construction surface area 22 of the construction platform 18, this surface area presently planar and running along the x/y axis of the device 10, for a layer-by-layer and local melting and/or sintering of the component material 17.

The high-energy beam 24 can be deflected by means of a deflection device 26 onto different regions of the powder layer 16 and can be focused onto the construction surface area 22. In addition, the device 10 comprises at least one measurement system 28, by means of which a cross-sectional geometry of the high-energy beam 24 on the powder layer 16 and/or an already produced component layer 30 can be determined. The measurement system 28 is preferably integrated, or at least can be integrated, into the beam path of the high-energy beam 24, in order to detect at high resolution the cross-sectional geometry on the powder layer 16.

In order to be able to assure the adjustment of an exact focusing of the high-energy beam 24 during the entire manufacturing process of the component 12, the device 10 according to the invention additionally comprises an equilibration device 32, which is designed in order to determine, based on the cross-sectional geometry of the high-energy beam 24, an also present planar focus area 34 of the high-energy beam 24, in order to examine whether an inadmissible deviation is present between the construction surface area 22 and the focus area 34 of the high-energy beam 24, and, if needed, to again correctly align the construction surface area 22 and the focus area 34 to one another as a function of the examination. The alignment is preferably carried out by means of the deflection device 26, for which basically at least two different embodiments can be provided. Alternatively or additionally, the relative alignment of construction surface area 22 and focus area 34 can be carried out also, however, by a relative movement of the construction platform 18 with respect to the radiation source 20.

In the case presently shown, the deflection device 26 comprises a so-called f-theta objective 36, in order to realize a planar focus area 34. This type of deflection device 26 will be designated below as “machine type 1”. This focus area 34 has been hitherto adjusted once or in a complex manner after changing the optics. For reasons that are still not clear today, it happens that this focus area 34 over time tilts and/or moves relative to the construction surface area 22. Disruptions in the process and as a consequence of this, material defects in the component 12 arise therefrom, since a correct focusing is no longer possible. Instead of an f-theta objective 36, a dynamic focusing system (not shown) can also be provided. This alternative type of deflection device 26 will be designated below as “machine type 2”. Advantageously, in the case pf machine type 2, one can dispense with the planar field optics of machine type 1. Instead of this, the focus area 34 can be adjusted synchronously with the incident position of the high-energy beam 24 on the powder layer 16 or construction surface area 22 by dynamic focusing. These focusing systems are also usually calibrated once in a complex process, but are also subject to drift thereafter, which can lead to an undefined maladjustment of the focus area 34.

Deviations in the focus area 34 and process disruptions associated therewith can be avoided by monitoring the correct position of the focus area 34 and, if necessary, recreating or re-adjusting it by means of the device 10 according to the invention. This control or regulation can be conducted basically at any time, thus in fact online during the construction job. As already mentioned, for this purpose, first the focus area 34 is determined by means of the cross-sectional geometry of the high-energy beam 24 measured on the powder layer 16 or the component layer 30. Subsequently, deviations between the construction surface area 22 and the focus area 34 are examined. If the deviation of the focus area 34 to the construction surface area 22 is classified as inadmissible, the equilibration device 32 actuates two, and preferably three, adjustment means 40 in the case of the machine type 1, by means of which adjustment means, the f-theta objective 36, which is movably mounted, can be moved in at least three translational and/or rotational degrees of freedom. In this way, the construction surface area 22 and the focus area 34 can again be aligned coplanar. Alternatively, a parallel kinematic system can be provided, by means of which the f-theta objective 36 is movable in six degrees of freedom.

In the case of the machine type 2, the equilibration device 32 determines an equilibration function for the dynamic focusing system of the deflection device 26, preferably by interpolation. This equilibration function can then be applied to the regular actuation data of the radiation source 20 and/or the deflection device 26, in order to conduct an automatic focusing correction.

By integrating the measurement system 28 into the beam path of the laser 24, it is possible to produce a very high-resolution image of the laser spot. The measurement system 28 shall be adapted for this purpose to the wavelength of the operating laser (e.g. 1064 nm) in order to be able to optimally image the laser spot. Based on the size and shape of the laser spot, it is established whether the laser 24 is in focus. This can be conducted, for example, by comparison with a pre-specified cross-sectional surface value, which was previously defined once. Alternatively, the minimum cross-sectional surface area can be determined by moving the construction platform 18 and continually recording the laser spot geometry. When the cross-sectional surface area reaches a minimum, the laser 24 is in focus. In order to bring the focus area 34 into coincidence with the construction surface area 22, the following steps can be carried out.

As already described for the coating device 14, first the construction platform 18 is aligned, in order to assure a uniform application of powder. Subsequently, the focus area 34 of the laser optics is determined on the basis of at least 3 measurement points. The radiation source 20 is preferably operated with low power thereby, in order to prevent an undesired melting or sintering of the material. When it is integrated into the beam path, the measurement system 28 automatically measures, at the correct position, the diameter of the laser spot or its cross-sectional geometry on the construction surface area 22. Alternatively, the measurement system 28 is actively aligned on the respective measurement point. Subsequently, the construction platform 18 is moved along a specific path in the z-direction (double arrow Ib), continuously or in small steps by a defined step. In this case, the step preferably corresponds to at least the Rayleigh length of the high-energy beam 24 and thus in the case of a laser, lies in the range between approximately 20 mm and approximately 60 mm, in particular between 30 mm and 50 mm. In the case of a stepwise movement, the step width preferably corresponds to approximately 10% of the Rayleigh length. In one embodiment of the invention, during the movement of the construction platform 18, the cross-sectional geometry of the laser spot (x, y measurement values) and the z measurement values, which are detected, for example, by a glass ruler (measuring instrument of the z-axis), are determined continuously. As soon as the laser beam 24 is in focus, the corresponding (x,y,z) coordinates of the associated measurement point are stored. This procedure is carried out on at least 3 measurement points that are not disposed collinear and are spaced as far apart as possible from one another. From the coordinate tuples obtained therefrom, the equilibration device 32 determines a plane equation that characterizes the optimal focus area 34. In the case of machine type 1, the f-theta objective 36 is now moved or tilted via the adjustment means 40, in order to arrange the focus area 34 to again be congruent with the construction surface area 22. If needed, this procedure can be repeated iteratively until the required accuracy is reached. Likewise, a correction of the machine coordinates can be provided, since the lens position of the f-theta objective 36 has an influence on the calibrated machine coordinates. In the case of machine type 2, the equilibration device 32 determines from the determined coordinate tuples an equilibration function that is applied to the actuating data or the construction data of the optical system of the device 10, in order to again produce for each point of the construction surface area 22 the correct actuation of the dynamic focusing system. Basically, the device 10 according to the invention can be designed or can be used both for pure monitoring, i.e., for monitoring whether the focus area 34 is correctly disposed, as well as for the control or regulation of the alignment of the focus area 34.

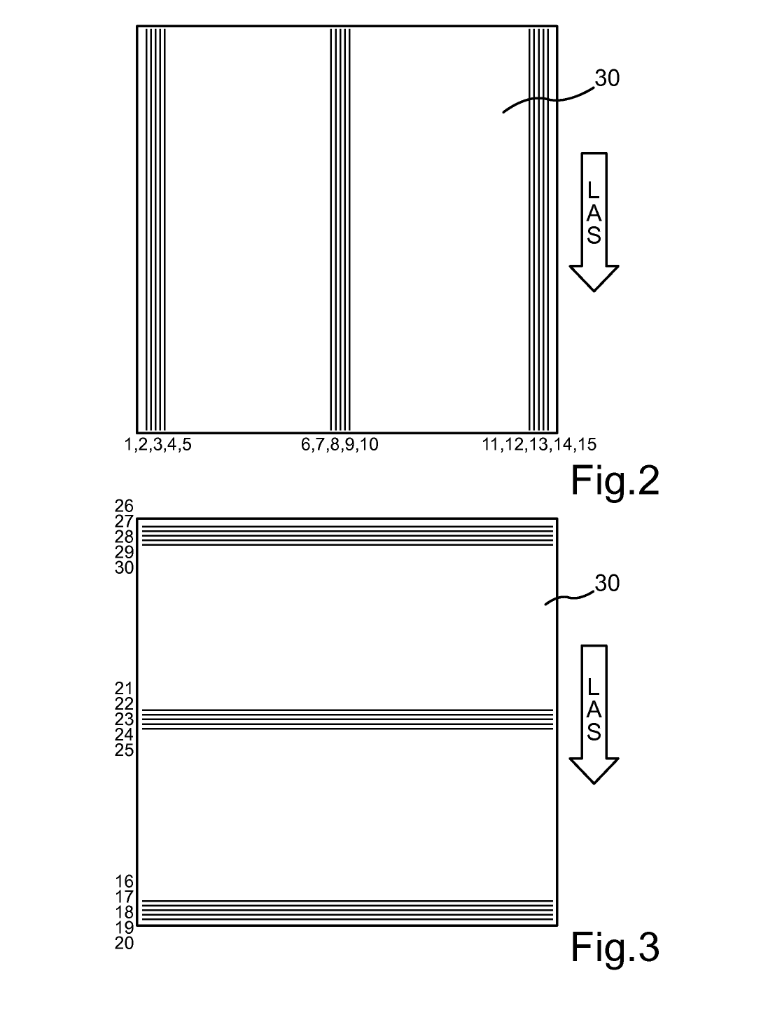

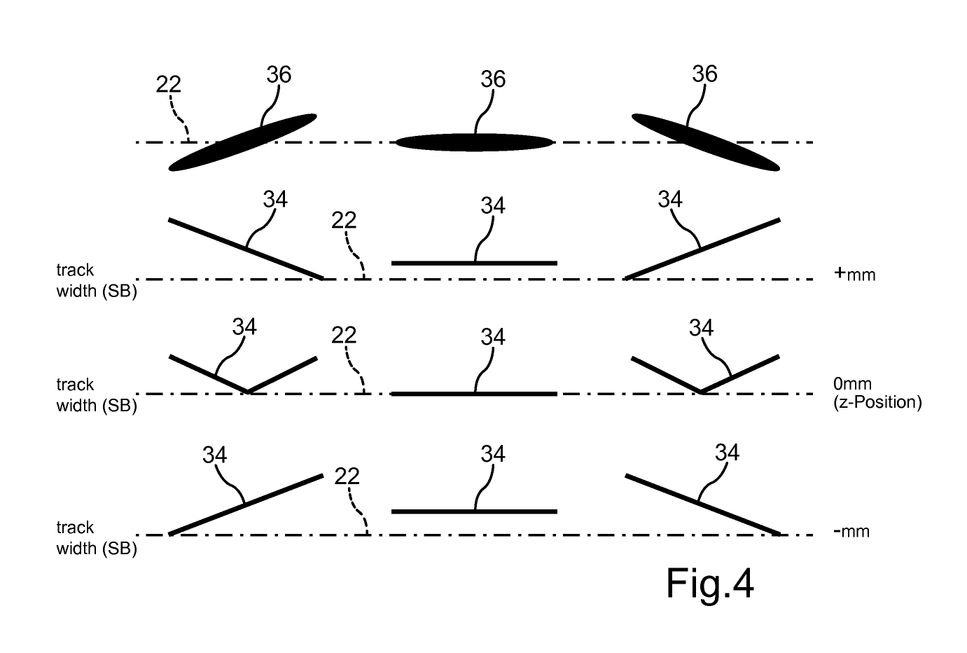

For a more detailed explanation of the problem of deviating focus areas 34, FIG. 2 and FIG. 3 show a schematic top view of a component layer 30, which had been exposed to 15 individual vectors aligned parallel and against the flow (FIG. 2) or perpendicular (FIG. 3) to a direction of laser exposure designated LAS. FIG. 4 shows an illustration of the principle of the track widths of the individual vectors resulting therefrom. Each time, the individual vectors were bundled into groups of five and exposed at a specific position of the construction surface area 22. In this case, the z-position of the construction platform 18 was varied according to the double arrow lb shown in FIG. 1. The positions of the construction platform 18 referred to the ideal z-position 0, i.e., the one in focus, were: −2 cm, −1 cm, 0, +1 cm and +2 cm. It should be emphasized that this number of steps and step width are given only by way of example. Correspondingly, the individual vectors 1, 6, 11, 16, 21, 26 were exposed at the z-position −2 cm; the individual vectors 2, 7, 12, 17, 22, 27 were exposed at the z-position −1 cm; the individual vectors 3, 8, 13, 18, 23, 28 were exposed at the z-position 0; the individual vectors 4, 9, 14, 19, 24, 29 were exposed at the z-position +1 cm; and the individual vectors 5, 10, 15, 20, 25, 30 were exposed at the z-position +2 cm. Subsequently, the track width of each individual vector was measured at three measurement points. In the case of the individual vectors shown in FIG. 2, measurement was made parallel to the flow at the upper edge, in the center, and at the lower edge. In the case of the individual vectors shown in FIG. 3, measurement was made perpendicular to the flow at the left edge, in the center, and at the right edge.

The effects of the erroneous position of the f-theta objective 36 relative to the construction surface area 22 on the resulting track widths (SB) of the individual vectors are shown in FIG. 4. A widening of the track based on floating oxides or the like was not observed. It is recognized that the focus area 34 is aligned coplanar with the exposure surface area 22 and thus correctly only in the case of the centered exposure in the z=0 position. In all other cases, deviations result between the focus area 34 and the exposure surface area 22, which, without correction and alignment of the focus area 34 and the exposure surface area 22 to one another, would lead to distortions of the laser spot and thus to non-uniform and imprecise energy input into the powder layer 14 with corresponding formation of defects in the later component 12.

What is claimed is:

1. A device (10) for the additive manufacture of a component (12), comprising at least one coating device (14) for producing a powder layer (16) on a construction platform (18); at least one radiation source (20) for producing a high-energy beam (24), wherein the powder layer (16) in a construction surface area (22) can be melted and/or sintered locally to form a component layer (30); at least one deflection device (26), wherein the high-energy beam (24) can be deflected onto different regions of the powder layer (16) and can be focused on the construction surface area (22); at least one measurement system (28), wherein a cross-sectional geometry of the high-energy beam (24) on the powder layer (16) and/or the component layer (30) can be determined; and at least one equilibration device (32) that is configured and arranged to:
determine a focus area (34) of the high-energy beam (24) on the basis of the cross-sectional geometry of the high-energy beam (24);
examine whether a deviation is present between the construction surface area (22) and the focus area (34) of the high-energy beam (24); and
to align the construction surface area (22) and the focus area (34) to one another as a function of the examination.

2. The device (10) according to claim 1, wherein the deflection device (32) comprises at least one an f-theta objective optical lens (36), the relative position of which, as a function of the examination, can be adjusted with respect to the radiation source (20) by at least one associated adjustment means (40).

3. The device (10) according to claim 2, wherein a parallel kinematic system, is associated with the at least one optical lens (36), the at least one optical lens being movable in at least three translational and/or rotational degrees of freedom.

4. The device (10) according to claim 1, wherein the equilibration device (32) is configured and arranged to adapt an actuation of the radiation source (20) and/or of the deflection device (26) as a function of the examination.

5. The device (10) according to claim 1, wherein the measurement system (28) is integrated in a beam path of the high-energy beam (24) and/or is designed to determine the cross-sectional geometry of the high-energy beam (24) collinear to the high-energy beam (24).

6. The device (10) according to claim 1, wherein the equilibration device (32) is configured and arranged to adjust a relative position of the construction platform (18) with respect to the radiation source (20) as a function of the examination.

7. The device (10) according to claim 1, wherein the equilibration device (32) is configured and arranged to determine the focus area (34) based on a comparison between at least one determined cross-sectional geometry of the high-energy beam (24) and at least one pre-specified cross-sectional geometry, and/or based on the cross-sectional geometry of the high-energy beam (24) in at least three non-collinear measurement points, and/or based on at least one minimum cross-sectional geometry of the high-energy beam (24) at one measurement point.

8. The device (10) according to claim 1, wherein a measuring instrument fabricated additively with the component is associated with the equilibration device (32) by which a distance can be determined between the radiation source (20) and the powder layer (16); the measurement device is selected from the group consisting of a glass ruler and a test bar.

9. The device (10) according to claim 1, wherein
at least one cross-sectional geometry of the high-energy beam (24) on the powder layer (16) and/or the component layer (30) by the measurement system (28) is determined;
the focus area (34) of the high-energy beam (24) based on the at least one cross-sectional geometry of the high-energy beam (24) by the equilibration device (32) is determined;
by the equilibration device (32), whether a deviation is present between the construction surface area (22) and a focus area (34) of the high-energy beam (24) is examined; and
the construction surface area (22) and the focus area (34) to one another as a function of the examination is aligned.

10. The device (10) according to claim 9, wherein the power of the high-energy beam (24) is adjusted during the determination of the cross-sectional geometry so that the powder layer (16) is not melted and/or sintered at the measurement point.

11. The device (10) according to claim 9, wherein the focus area (34) of the high-energy beam (24) is determined based on the cross-sectional geometry of the high-energy beam (24) in at least three non-collinear measurement points.

12. The device (10) according to claim 9, wherein the construction platform (18) is moved for determining a minimum cross-sectional geometry of the high-energy beam (24) relative to the radiation source (20).

13. The device (10) according to claim 12, wherein, for determining the minimum cross-sectional geometry, the construction platform (18) is moved continually, and/or at least by the Rayleigh length of the high-energy beam (24), and/or by at least 20 mm, and/or stepwise by a pre-specified step of 10% of the Rayleigh length of the high-energy beam (24).

14. The device (10) according to claim 9, wherein at least the examination of whether a deviation is present between the construction surface area (22) and the focus area of the high-energy beam (24) is carried out continuously, and/or at pre-specified time intervals, and/or after each component layer (30) is produced, and/or prior to a pre-defined component layer (30), and/or as a function of a heating of the device (10).
